(19) United States
(12) Patent Application Publication
(10) Pub. No.: US 2004/0057428 A1
(43) Pub. Date: Mar. 25, 2004

(54) Method for operating an access network for a mobile radio system

(76) Inventors: Jurgen Gerstner, Ehingen-Rissthissen (DE); Stephan Hauth, Ulm (DE); Jochen Metzler, Mainz (DE)

Correspondence Address: STAAS & HALSEY LLP, SUITE 700, 1201 NEW YORK AVENUE, N.W., WASHINGTON, DC, 20005, US

(21) Appl. No.: 10/381,278

(22) PCT Filed: Sep. 20, 2001
(86) PCT No.: PCT/DE01/03637

(30) Foreign Application Priority Data
Sep. 22, 2000 (DE) 100 47 131.5

(51) Int. Cl. H04Q 7/00; H04L 12/56

(52) U.S. Cl. 370/389; 370/338; 370/328

(57) ABSTRACT

The invention relates to a method for supporting the quality of service (QoS) in packet data transmission between a wireless terminal (MT), having data communication with a radio access network, and a data network (LN), in which method data transmission between the terminal (MT) and the radio access network (2) is controlled by at least one mobile IP router (5, 5′, 5″). Further, in the method data is transmitted in radio flows between the wireless terminal (MT) and the mobile IP router (5, 5′, 5″). In the method, a flow label is defined for at least one radio flow and the desired quality of service is defined for the radio flow.

Data appointed to a terminal is transmitted between two nodes of an access network in IPv6 packets. The flow label field of an IPv6 packet is used for transmitting an item of information by which the node that receives the packet makes a selection among a number of paths on which the packet can be routed.

### DESCRIPTION

The present invention relates to a method for operating an access network for a mobile radio system in which data destined for a terminal is transmitted between two nodes of the access network in IP packets.

An access network constitutes the bridge between individual mobile terminals and a primary network or core network in which information from a large number of connections between mobile terminals or between a mobile terminal and another data source or data sink such as the internet is transmitted by wire.

The access networks of third generation mobile radio systems such as the UMTS system are built on ATM network technology. Based on this technology are protocol systems that differ depending on which of the various types of node within the access network is involved and whether transmission is connection-oriented, that is to say essentially voice transmission, or packet-oriented, that is to say essentially the transmission of data services.

Known access networks have different types of node at a multiplicity of hierarchical levels. Forming a top level are nodes known as access network gateways, abbreviated to gateways, which constitute the interface in each case to the primary network. The nodes found at the level immediately below this level are designated access network nodes. Nodes at the lowest hierarchical level, which communicate directly with the terminals by radio, are designated transceivers. Each transceiver has at its disposal a certain number of signal carriers, which can be used individually or in combinations for communication with the terminal depending on the bandwidth required by a terminal.

A protocol stack including an IP layer and, based thereon, a UDP layer and a GTP-U tunnel is disclosed for the packet-oriented transmission of data between the gateway and the lower level nodes in 3GPP TS 29.060 “General Packet Radio Service (GPRS); GPRS Tunneling Protocol (GTP)”. This complicated structure of layers is necessary because only individual nodes of the access network can be addressed in the IP protocol layer of the access network; it is not possible to address a terminal or a functional unit that prepares the data for transmission to the terminal. Additional protocol layers that permit the gateway to insert the information into the IP packets as payload are required in order to transport address information via the receiver terminal. This information is extracted again at the level of the access network node. The access network node uses it to select a signal carrier on which the receiver terminal expects to receive the packet.

An explicit AAL2 connection is set up between the gateway and the access network node communicating with the terminal in the case of connection-oriented transmission to a terminal. Allocation of this connection to one or more signal carriers of a transceiver is recorded at the access network node. The access network node can thus determine the signal carrier on which this information must be broadcast by means of the AAL2 connection over which it receives information.

A discrete AAL2 connection is set up for each signal carrier at a lower hierarchical level between the access network node and the transceiver. This enables the transceiver to recognize, by means of a reference table and the AAL2 connection over which it receives a data packet, the signal carrier selected by the access network node for sending the packet.

The object of the present invention is to specify an operating method for an access network that permits universal operation of the access network using IP transport technology and in the process avoids the excesses of processing work and data volume to be transmitted that result from a complicated protocol stack.

The object is achieved by a method for operating an access network for a mobile radio system in which data destined for a terminal is transmitted between two nodes of the access network in IP packets and which is characterized in that the packets are IPv6 packets and in that the flow label field of an IPv6 packet is used for transmitting an item of information by means of which the node that receives the packet makes a selection among a number of paths on which the packet can be routed. This selection comprises a single path in each instance in the case of a point-to-point connection, but it is also possible to select multiple paths at the same time in the case of a point-to-multipoint connection.

The flow label field of the IPv6 protocol has a length of 20 bits. This equates to a quantity of somewhat more than one million possible values. The number of terminals in an access network can easily exceed this value, however, with the result that definitive identification of all terminals by means of the aforementioned item of information is no longer possible if the latter contains a designation in the form of a name permanently allocated to each terminal. These terminals are generally never all active at the same time, however, so the problem can be overcome by using as the item of information an identifier that is uniquely allocated to a data flow when this data flow is set up. The identifier can be allocated again once the data flow has ended.

The identifier need only be unique between two nodes (for example between gateway and access network node or between access network node and transceiver) in the access network. A first node may use an identifier that it is using to identify a first data flow in communication with a second node to identify any other data flow in communication with a third node.

Another way to increase the number of terminals that can be distinctively identified using the aforementioned item of information is to allocate to a node of the access network a multiplicity of network addresses, to assign different data flows between this node and a second node an identical identifier in combination, in each case, with a different one of the multiplicity of network addresses and to refer to the network address as well as the identifier when selecting the path along which to route the packet.

Another way to increase the number of terminals that can be distinctively identified using the aforementioned item of information is to extend the item of information over the traffic class field of the IPv6 packets.

Using the traffic class field in this way does not, however, mean having to manage without a differentiation by grade of service classes for different data streams. Instead the traffic class field can be assigned a twofold function. If, for example, (n1, n2) is a first item on information that designates a first data flow, n1 being the content of the traffic class field and n2 the content of the flow label field, this data flow is conveyed through the access network with the grade of service designated by n1. A second item of information (n1′, n2) having the same value n2 for the flow label may designate a completely different data flow leading to a different terminal with the grade of service defined by n1′. The transport network is to be configured here in such a way that it does not modify the traffic class field.

The item of information may be an identifier for a terminal or for a data flow destined for the terminal. There is no difference between the two alternatives provided that a terminal maintains only a single data flow. Modern mobile radio terminals such as UMTS terminals in particular will, however, be in a position to operate a multiplicity of data services, such as voice telephony, telefax, internet access, etc., at the same time or, in the course of a connection, to change the service being used or make use of additional services. It is expedient in such a case to assign the data flow associated with each of these services its own identifier so that the receiving node can correctly allocate the data received to the different services. A method of this type is particularly well suited for transmission from a gateway node of the access network to a node at a lower hierarchical level of the access network such as an access network node.

An alternative option is for the item of information to be an identifier of a signal carrier to be used for radio transmission to the terminal. This variant is particularly well suited for transmission to a transceiver of the access network.

The two variants can of course be used simultaneously at the different hierarchical levels of one and the same access network.

Additional features and advantages of the invention are revealed in the enclosed description of an embodiment with reference to the enclosed figures.

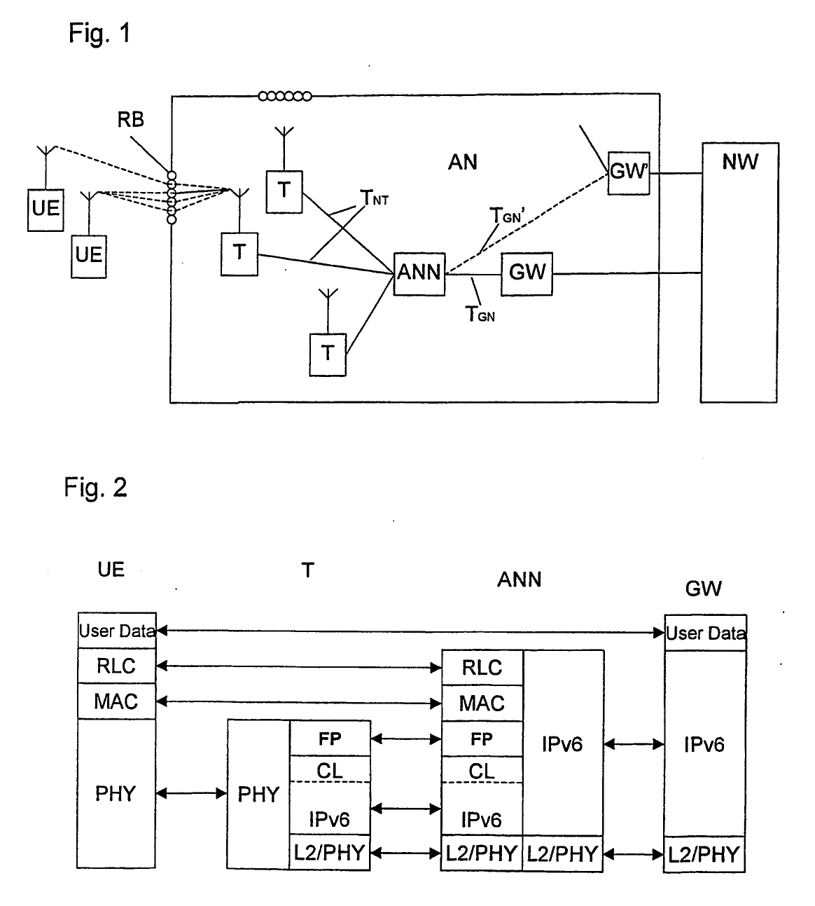

FIG. 1 shows a block diagram of an access network in which the method according to the invention can be used.

FIG. 2 shows the protocol structures used between the different nodes of the access network and between the transceivers and the terminals.

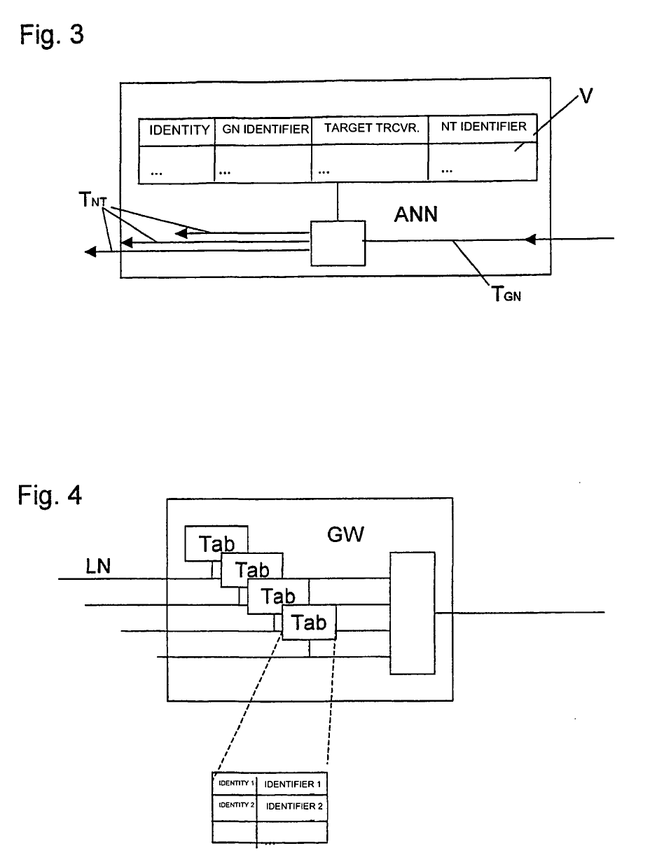

FIG. 3 shows a highly schematic representation of an access network node.

FIG. 4 shows a first example of a gateway node.

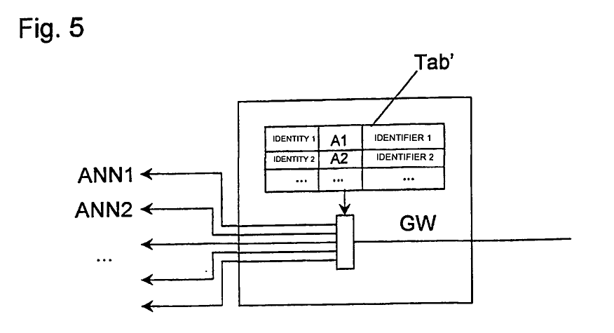

FIG. 5 shows an alternative example of a gateway node.

FIG. 1 shows a highly schematic representation of the structure of an access network AN for the transmission of information between terminals UE of a mobile radio communications system and a primary network NW. The access network AN has a hierarchical structure with different types of node at different hierarchical levels. Forming a top hierarchical level are nodes GW known as gateways, which are connected directly to the primary network NW. A second level is formed by nodes referred to here as access network nodes ANN, a multiplicity of which are allocated to each gateway node GW. Only one of these access network nodes ANN, connected to its allocated gateway node GW by a transmission link T_{GN}, is shown in the figure for the sake of simplicity. A multiplicity of transceivers T are in turn connected to each access network node ANN by transmission links T_{NT}, each of which is able to communicate with terminals UE by radio via a limited number of signal carriers RB.

Considered first is an access network having a simple tree structure in which each node of a given hierarchical level (where present) is connected to precisely one node of the hierarchical level immediately above it and (where present) to a multiplicity of nodes of the hierarchical level immediately below it.

In the case of a UMTS mobile radio system or in general of a code division multiplex mobile radio system, one of a plurality of orthogonal spread codes used by the transceiver node T corresponds to each signal carrier RB. Each signal carrier could be seen as equivalent to a channel in the case of a time division multiplex mobile radio communications system.

FIG. 2 illustrates the protocol layers used between the nodes of the various hierarchical levels of the access network shown in FIG. 1. The gateway node GW, the access network nodes ANN and the transceivers T communicate by wire, while the underlying layer L2/PHY may be based on a transmission technology such as ATM, Ethernet, etc.

Based on this layer is an IPv6 layer. Data received by the gateway GW from the primary network NW and destined for a specific terminal UE forms the payload, without any additional intermediate protocol layers, of IPv6 packets exchanged between the gateway node GW and the access network nodes ANN. These packets contain the address of an access network node ANN as target address. Information that tells the receiving access network node ANN where the packets are to be sent is contained in the flow label field and, where appropriate, the traffic class field of the packets. The evaluation of these fields by the access network node ANN is examined in more detail below.

The access network node ANN allocates to a packet received from the gateway GW the signal carrier on which the terminal expects to receive the packet, a time of origin, etc. as a function of the information in the flow label field and/or the traffic class field specifying the receiver terminal. Packets transmitted from the access network node to the transceiver node T therefore no longer need to contain any explicit item of information concerning the receiver terminal: it is sufficient to specify the signal carrier. This is illustrated in FIG. 2 by the signaling entities RLC (radio link control) and MAC (medium access control) transmitted to the terminal UE by the transceiver node T without any influence from the latter.

A convergence layer CL may be required in the communication between access network node and transceiver node, especially in the case of voice transmission, to ensure that the packets are transmitted by radio to the terminal UE in the correct chronological order.

There follows a detailed examination of the structure and implementation of a data flow between gateway GW and a terminal UE. Consideration is given initially only to transport in the downlink direction. The other direction is discussed later.

The need to set up a new data flow may arise because the terminal UE directs a request to this effect to the access network or because the gateway GW receives data for routing to a terminal UE with which no data flow is currently in place. Whichever case applies, the access network node ANN receives a signaling message indicating the identity, for example the calling number or IMSI, or the terminal UE concerned and the required grade of service.

The access network node ANN shown in FIG. 3 has at its disposal a directory V in which are stored, together with the identities of the associated terminals, an identifier, designated the GN identifier, for traffic with the gateway GW allocated to it and an identifier, designated the NT identifier, for traffic with the allocated transceivers T for each of the data flows currently proceeding through the access network node. The GN identifiers consist in each case of a first part designating the grade of service of the data flow and a second part selected arbitrarily. The network access node ANN generates a GN identifier for the new data flow to be set up by selecting a second part that has not yet been allocated in traffic between it and the gateway GW in combination with the grade of service requested for the data flow. The same second part may already be allocated for a data flow in combination with another grade of service or between other nodes without compromising the uniqueness of the identifier thus formed.

The selected GN identifier is transmitted to the gateway node GW, where it is recorded in a table together with the identity of the terminal.

A first variant shown in FIG. 4 provides for such a table Tab to be set up at the gateway node GW for each of the access network nodes ANN connected thereto.

The GN identifiers do not have to be unique at the level of the gateway node GW, as the latter, if faced with a multiplicity of identical GN identifiers assigned by different access network nodes ANN, is able to use the table Tab, in which it finds the GN identifier for a given terminal identity, to recognize the access network node ANN to which a packet labeled with the identity and received from the primary network has to be transmitted. This table Tab may be pictured in each case as individual storage elements or as limited regions within a larger storage module. The location in which a given terminal identity and the associated identifier are stored makes it possible in either case for the gateway GW to conclude which access network node ANN is to be sent the packet provided with the GN identifier found.

The gateway node can of course, in a second variant shown in FIG. 5, maintain a unified table Tab′, each of the entries in which contains a terminal identity, the assigned GN identifier and the address A1, A2 . . . of the access network node ANN that assigned the identifier for a dataflow of the terminal and to which the packet is to be sent, rather than the multiple tables.

The access network node ANN also allocates the terminal UE a transceiver node T, via which the terminal UE may be reached by radio, a free signal carrier at this transceiver node T. The address of this target transceiver is also stored in the directory V of the access network node ANN. The combination of allocated transceiver T, signal carrier and possibly also functional unit defines a path for the routing of the data packet.

The access network node ANN now selects an NT identifier still unused in the communication with the allocated transceiver T and stores it in its directory V together with the identity of the terminal.

The NT identifiers in each case identify on a one-to-one basis one of the different signal carriers at the disposal of the transceiver T.

When a data packet labeled with a complete set of address information arrives at the gateway node GW from the primary network NW, the gateway node uses its tables to determine the GN identifier associated with this address information and the access network node ANN that allocated this identifier. It enters the GN identifier in the flow label field and possibly also in the type of service field of an IPv6 packet with which it routes the data received to the access network node ANN determined. This GN identifier alone is sufficient to specify the full path of the data packet through the access network. The address, used in the primary network, of the receiver terminal UE is no longer required for the subsequent transmission of the packet.

The access network node ANN receives the packet and uses its directory to determine the transceiver or transceivers T to which the packet has to be routed and the NT identifier of the signal carrier that the transceiver T concerned must use in order that the packet can be received correctly by the receiver terminal. The access network node ANN generates a new IPv6 packet with the data destined for the terminal UE as payload, which IPv6 packet contains as receiver address the IP address or addresses of the transceiver or transceivers T in the radio range of which the terminal UE is located and has in its flow label field the NT identifier, in other words the designation of the signal carrier, via which the terminal UE expects to receive data. It is no longer necessary to provide any more than the specification of the signal carrier at this stage of the transmission of the packet in order to ensure that the packet can be routed correctly to the terminal UE.

The description above assumes that the access network node allocates a GN identifier, which it then also communicates to the gateway node. It is of course also possible, as an alternative, for the GN identifier to be allocated by the gateway node and then transmitted to the access network node. Each NT identifier can also, in the same way, be defined by the transceiver T and transmitted to the access network node ANN.

Thus far only the case of the downlink transmission from the gateway GW to the transceiver T has been considered. The same method can also be used, with minor modifications, for transmission in the opposite direction. Different identifiers can here be allocated independently of each other for the uplink and downlink elements of one and the same data flow.

A TN identifier for transmission from transceiver T to the access network node ANN and an NG identifier for transmission from access network node to the gateway GN are defined in a manner analogous to that described above for the downlink. Each data packet sent subsequently by the terminal UE is sent by the transceiver T in an IPv6 packet addressed to the access network node ANN with a TN identifier corresponding to the signal carrier used by the terminal UE. The access network node determines the NG identifier allocated to the transceiver T and the TN identifier in its directory and sends a new packet to the gateway in which the TN identifier is replaced by the NG identifier. The gateway GW ascertains the identity of the receiver terminal UE′ using its table or tables and routes the packet for its part in accordance with this identity.

The method described, as can be seen, makes it possible to use a uniform transport infrastructure in the entire access network right through to the transceiver. All data transmission can be undertaken using standard IETF protocols, which reduces costs and improves the availability of components as well as simplifying their further development.

Corresponding advantages can be realized by a simplified variant of the method in which just the flow label field of an IPv6 packet is used for the identifier. The only limitation that this simplification produces is that given the flow label field length of 20 bits, an access network node cannot serve more than 2²⁰ active data flows simultaneously. It is easy, using a suitable network geographical structure, to keep the number of terminals in the area of an access network node small enough to ensure that the number of 2²⁰ data flows is not exceeded.

If it is necessary to manage more data flows at one node than the 2²⁰ possible by using the flow label field or the even larger number possible by simultaneously using the traffic class field, this node can be allocated multiple network addresses and the identifier can be evaluated in each case with reference to the network address as well.

The case in which the gateway GW is allocated two network addresses A1, A2 is considered as an example. There is one set of the gateway tables described above for each address or alternatively there is one table in which an allocated address of the gateway is entered for each terminal identity in addition to the assigned GN and/or NG identifier. When this gateway receives a packet provided with a terminal identity from the primary network NW, it routes it to the access network node ANN determined in the table or tables by means of this identity and adds to the packet sent to the access network node as sender address that address found in the corresponding table entry. The directories of the access network node ANN, in a corresponding manner, contain a specification of the sender address for every entry of a data flow, which makes it possible for the access network node to distinguish between two packets sent to it with the same GN identifier but destined for different data flows, to allocate each of these packets the correct NT identifier and to route them. Working in the opposite direction, an access network node can send packets having the same identifier to different gateway addresses as receiver addresses on the uplink to this gateway GW, whereby it is possible to assign this identical identifier to different receiver terminals as a function of the receiver address.

It is of course also possible to allocate a multiplicity of addresses to one access network node, it being necessary in such a case for the data packets sent by this node to be processed at the gateway GW or the connected transceivers T as a function of the sender address using differentiated tables.

Taking the sender address into account when processing the data packages, moreover, permits the access network to have a more flexible structure: instead of a network with a pure tree structure, in which each node is connected to precisely one node of the hierarchical level immediately above, an interlaced network structure can be used in which connections to multiple nodes of the hierarchical level immediately above can occur. This case is shown by way of example in FIG. 1 for the access network node ANN by the connection, indicated by the dashed line, to a second gateway GW′. A receiver node can distinguish between different sender nodes using the sender address included in every packet and can route a packet correctly in each case on the basis of an identifier defined in relation to every possible sender node (or more accurately every possible sender address).

The description above assumes an access network having three hierarchical levels for the sake of simplicity. It is, however, self-evident that the present invention can also be applied to access networks exhibiting more than three hierarchical levels and to those having fewer than three hierarchical levels, the latter being, in other words, access networks in which functions allocated to nodes of different hierarchical levels in the present description are realized by a single node.

1. Method for operating an access network for a mobile radio system in which data destined for a terminal (UE) is transmitted between two nodes (GW, ANN; ANN, T) of the access network (AN) in IP packets, characterized in that the packets are IPv6 packets, and that the flow label field of an IPv6 packet is used for transmitting an item of information by means of which the node (ANN; T) that receives the packet makes a selection among a number of paths on which the packet can be routed.

2. Method according to claim 1, characterized in that the item of information also extends over the traffic class field of the IPv6 packets.

3. Method according to claim 2, characterized in that the content of the traffic class field is still considered when defining a grade of service with which data is transmitted to a signal carrier (RB) designated in the item of information.

4. Method according to one of the preceding claims, characterized in that a source address and/or target address of the IPv6 packets is/are also considered when making the selection.

5. Method according to one of the preceding claims, characterized in that the item of information is an identifier of a terminal (UE) or of a data flow destined for the terminal.

6. Method according to claim 5, characterized in that it is used for transmission between a gateway node (GW) of the access network and a node (ANN) at a lower hierarchical level of the access network (AN).

7. Method according to one of claims 1 to 4, characterized in that the item of information is an identifier of a signal carrier (RB) to be used for radio transmission to the terminal (UE).

8. Method according to claim 7, characterized in that it is used for transmission to a transceiver node (T) of the access network (AN).

9. Method according to one of the preceding claims, characterized in that the identifier is allocated when the data flow is set up.
